(19) United States
(12) Patent Application Publication
(10) Pub. No.: US 2025/0045631 A1
(43) Pub. Date: Feb. 6, 2025

(54) ACTIVE LEARNING SYSTEM USING GENERATIVE WEAK SUPERVISION FOR KNOWLEDGE EXTRACTION

(71) Applicant: NEC Laboratories Europe GmbH, Heidelberg (DE)

(72) Inventors: Guerkan SOLMAZ, Heidelberg (DE); Flavio CIRILLO, Heidelberg (DE)

(21) Appl. No.: 18/712,715

(22) PCT Filed: Nov. 26, 2021
(86) PCT No.: PCT/EP2021/083220

§ 371 Date: May 23, 2024

(51) Int. Cl. G06N 20/00

(52) U.S. Cl. CPC G06N 20/00

(57) ABSTRACT

A computer-implemented machine learning (ML) method is provided. The method includes computing a labeling matrix by applying a set of labeling functions (LFs) to data points of an unlabeled dataset. A projected labels matrix is generated by computing, based on the labeling matrix, LFs labels projections to undefined labels. An uncertainty of a respective label of the each labeled data point is estimated for each labeled data point based on an output of the LFs and the LFs labels projections. Data points are selected depending on the uncertainty estimated for the respective label of the each data point, and a labeling request for the selected data points is submitted to an oracle and updating the labeling matrix according to responses of the oracle.

### CROSS REFERENCE TO RELATED APPLICATIONS

This application is a U.S. National Phase application under 35 U.S.C. § 371 of International Application No. PCT/EP2021/083220, filed on Nov. 26, 2021. The International Application was published in English on Jun. 1, 2023 as WO 2023/094001 A1 under PCT Article 21(2).

### FIELD

The present invention generally relates to a computer-implemented machine learning, ML, method and an ML system. More specifically, the present invention provides a machine learning method and system that combines an active learning strategy and data programming.

### BACKGROUND

In recent years, supervised machine learning (ML) has been adopted successfully in many scenarios, especially with the usage of deep machine learning that reduces the costs for features engineering relying on the computation power achieved by newest computers. However, to build a ML model that reaches good performance by training, it is necessary to have a very extensive dataset with labels (ground truth). Usually, labeling a dataset for training is tedious and very costly since often it may require an oracle (e.g. domain experts such as an operational team in an airport) to accomplish this task.

To address this issue, data programming (as described, e.g., in Alexander Ratner et al.: “Snorkel: Rapid training data creation with weak supervision”, in Proceedings of the VLDB Endowment. International Conference on Very Large Data Bases. Vol. 11. No. 3. NIH Public Access, 2017) has been proposed and used by various domains in industry, academia, and governments (for reference, see Christopher Ré et al.: “Overton. A data system for monitoring and improving machine-learned products”, in arXiv preprint arXiv1909.05372 (2019)). Data programming foresees to noisy annotate data points through a set of labeling functions. The output of the labeling functions is then de-noised through a labels aggregator (such as a generative machine learning model) and the resulting probabilistic labels are used to train a discriminative end-model, such as a supervised machine learning model. The end-model is then used for classifying data during the operational phase.

Although data programming promises labeling only through writing programs (labeling functions or LFs in short), as for any other machine learning system, there exist certain limitations of data programming related to classification accuracy. Often the LFs are labeling incorrectly or are not labeling at all corner cases that are critical for a correct training of the machine learning model. As a result, the end-model performance suffers due to lack of generalization to new data points to maintain high accuracy.

To address these limitations, active learning has been combined with data programming (for reference, see Anonymous, Uncertainty Based Active Learning Strategy for Interactive Weakly Supervised Learning through Data Programming, https://openreview.net/pdf?id=TU3ClDXYYQM). Active learning is a technique that considers the involvement of an oracle (e.g. a human domain expert) to annotate a selected set of data points until the machine learning model converge. Doing requests to an oracle is considered highly expensive (e.g., working time of a domain expert), thus, it is important to minimize the number of requests to the oracle by efficiently choose the data points to be annotated. Active learning techniques aim to identify important data samples to be annotated and later used for the machine learning model training. The combination of active learning and data programming can be considered a hybrid approach of supervised learning and weak supervision.

The existing combination of active learning and data programming approaches (as disclosed, e.g., in the aforementioned document) mostly consider the uncertainty for the prediction of the discriminative model (end classifier) of the data programming for choosing the set of data points to be labeled by the oracle. The main idea is to request the oracle to annotate data points that are not labeled and that the end classifier does not have much confidence on the predictions.

The uncertain estimation of existing systems of active learning with data programming relies on the training of the end model. However, the end model needs to have a decent amount of labeled training data to converge (especially if it is a CNN) and, thus, reaching an acceptable quality of uncertainty estimation. As such, existing systems prove to be disadvantageous since this requirement is often not satisfied due to the difficulty to implement enough labeling functions or their small coverage. Furthermore, in prior art systems, the end model needs to be fully re-trained for every cycle of active learning, which is time-consuming and costly, in particular if the end model is a CNN.

### SUMMARY

In an embodiment, the present disclosure provides a computer-implemented machine learning (ML) method, the method comprising: a) computing a labeling matrix by applying a set of labeling functions (LFs) to data points of an unlabeled dataset; b) generating a projected labels matrix by computing, based on the labeling matrix, LFs labels projections to undefined labels; c) estimating, for each labeled data point, an uncertainty of a respective label of the each labeled data point based on an output of the LFs and the LFs labels projections; d) selecting data points depending on the uncertainty estimated for the respective label of the each data point; and e) submitting labeling request for the selected data points to an oracle and updating the labeling matrix according to responses of the oracle.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic view illustrating an active learning system for data programming according to prior art,

FIG. 2 is a schematic view illustrating the application of active learning on a programmatic labeling ML system for knowledge extraction in the context of a smart airport use case, in accordance with an embodiment of the present invention,

FIG. 3 is a schematic view illustrating a processing pipeline of a system for knowledge extraction, in accordance with an embodiment of the present invention,

FIG. 4 is a schematic view illustrating an active learning system using generative machine learning for data programming, in accordance with an embodiment of the present invention,

FIG. 5 is a schematic view illustrating a generative weak supervision method, in accordance with an embodiment of the present invention,

FIG. 6 is a schematic view illustrating an active learning system for medical image processing, considering raw images along with patient records, in accordance with an embodiment of the present invention, and

FIG. 7 is a schematic view illustrating an active learning system for a humanitarian AI applications in the context of weapon contamination detection with UAV images, in accordance with an embodiment of the present invention.

### DETAILED DESCRIPTION

The project leading to this application has received funding from the European Union's Horizon 2020 research and innovation program under grant agreement No 871249.

In accordance with an embodiment, the present invention improves and further develops a method and a system of the initially described type in such a way that the labels collection efforts that may be required for generating a labeled dataset for a machine learning model are reduced.

In accordance another embodiment, the present invention provides a computer-implemented machine learning, ML, method, the method comprising:
a) computing a labeling matrix by applying a set of labeling functions, LFs, to data points of an unlabeled dataset;
b) generating a projected labels matrix by computing, based on the labeling matrix, LFs labels projections to undefined labels;
c) estimating, for each labeled data point, an uncertainty of the label based on the LFs output and the projected labels;
d) selecting data points depending on the uncertainty estimated for the data point's label; and
e) submitting labeling request for the selected data points to an oracle and updating the labeling matrix according to the oracle's responses.

Embodiments of the present invention propose a machine learning system that combines active learning system and data programming, thereby reducing the time and the costs for developing a machine learning model. Specifically, embodiments of the invention achieve a significant reduction of the time that may be required to annotate data and of the time that may be required to train an end classifier (e.g. a neural network). According to embodiments of the invention, an active learning procedures is applied, avoiding labels aggregation and end classifier training by estimating uncertainty using the LFs' outputs and the projected labels for each data point. The data points with highest uncertainty may be selected to be submitted to the oracle. As a result, the overall costs to develop a machine learning application are minimized through better active learning for hybrid data programming and hand-labeling approach.

In environments such as smart buildings (e.g., airports) and smart cities (e.g., urban digital twins), embodiments of the present invention would allow easier knowledge extraction using machine learning and provide context awareness for smart city or building management. Embodiments of the invention provide a novel system pipeline, which is achieved through a novel way of estimating uncertainty for ranking data points that should undergo active labeling. Generally, the present invention can be suitably applied in many technological fields, for instance in the area of healthcare and industrial IoT, to name just a few examples.

According to embodiments, steps b)-e) may be iteratively repeated until the projected labeling matrix contains a number of labels above a configurable threshold number.

According to an embodiment of the invention, probabilistic labels may be generated by aggregating labels from the projected labels matrix. In the end, these probabilistic labels may be used to train an end classifier. According to an embodiment, the end classifier may be trained with the probabilistic labels only once, namely after active labeling according to steps b)-e) is finished.

According to an embodiment it may be provided that the LFs labels projection to undefined labels is computed by applying ML techniques or heuristics. In this context, a heuristic may include, for instance, applying labels based on a number of stochastic encounters between a labeled and non-labeled data point by a LF and setting, based thereupon, a value close to the label given to the labeled data point.

According to an embodiment it may be provided that the step of generating the projected labels matrix is performed by calculating probabilities based on data features of non-labeled data points and the LF's outputs.

According to an embodiment it may be provided that the step of generating the projected labels matrix is performed depending on a distance function between data points. For instance, for a dataset composed of real number data features, the distance might be implemented by the Euclidean distance. In other embodiments, e.g. with data composed of text, the distance might be computed by pre-trained NLP (natural language processing) embedding. In a different embodiment with text data, the distance can be computed on a one-hot encoding of tokenized element.

According to an embodiment, the uncertainty of a label of a labeled data point may be estimated by machine learning algorithms, including using a decision tree or random forest, or heuristics.

According to an embodiment it may be provided that labels are projected with a confidence estimation for undefined labels after the LFs application using the computed labels from other data points and their features.

According to an embodiment of the invention, the selection of data points according to step d) may be performed by ranking the labeled data points according to the estimated uncertainty of the respective labels. In this context it may be provided that, in each iteration, a predefined number of the highest ranked labeled data points is selected for being forwarded to the oracle together with a request for labeling the data points.

According to embodiments, it may be provided that the labels that are acquired from the oracle are used to re-calculate uncertainty estimations. Moreover, such re-calculated uncertainty estimations may be a used to update the existing ranking of the data points.

In some embodiments, the LFs may be configured to already give a confidence of their annotation, rather than simply the class. In this context, it should be noted that the oracle labels (i.e. ground-truth) and the LFs labels may have a different confidence level.

There are several ways how to design and further develop the teaching of the present invention in an advantageous way. To this end, it is to be referred to the following explanation of preferred embodiments of the invention by way of example, illustrated by the figure on the other hand. In connection with the explanation of the preferred embodiments of the invention by the aid of the figure, generally preferred embodiments and further developments of the teaching will be explained. In the drawing

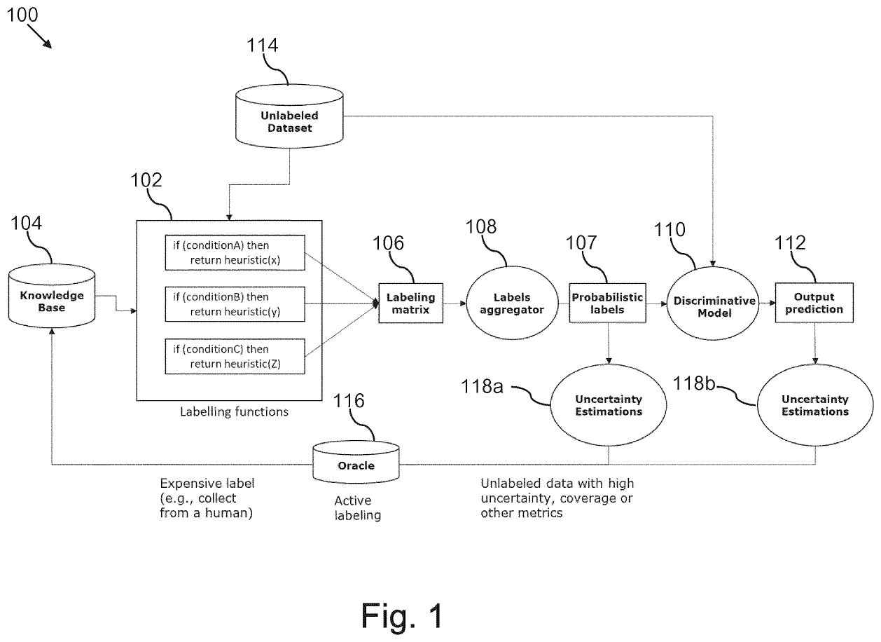

FIG. 1 illustrates the general concept of a prior art machine learning system 100 with a combination of active learning and programmatic labeling approach. In this concept, both labeling functions, LFs, 102 and labeled data points are gathered from a knowledge base 104 and fed to the data programming pipeline. Using the information from the knowledge base 104, a matrix 106 of labels is generated with rows referring to data points and columns referring to LFs 102. A labels aggregator component 108 (such as a generative model) and a discriminative model 110 (such as a supervised machine learning model) are trained, and the discriminative model 110 is used for output predictions 112 of unlabeled data of the unlabeled dataset 114. At this point, active learning techniques are used to select data points to be presented to the oracle 116 based on various metrics from the labels aggregator 108 and discriminative model 110 that identifies uncertainty (as disclosed in Anonymous: “Uncertainty Based Active Learning Strategy for Interactive Weakly Supervised Learning through Data Programming”, https://openreview.net/pdf?id=TU3ClDXYYQM), coverage or others. Respective uncertainty estimators 118a, 118b are depicted in FIG. 1. These data points are used to correct the labels aggregation and the training of the supervised ML model.

It should be noted that although FIG. 1 presents the general architecture of known active learning systems using data programming, small variations may exist in prior art. For example, in some systems the uncertainty estimations is only calculated using the output of the discriminative model 110 (i.e. with uncertainty estimator 118b only).

However, it may be necessary to train the discriminative end-model 110 in order to have meaningful uncertainty estimations. Systems that use only the output of the labels aggregator 108 (therefore using labeling matrix 106 and probabilistic labels 107) do not have enough information for a correct uncertainty estimation. Often the training of a discriminative model 110 is expensive in terms of resource consumption, such as a deep neural network (DNN) model for computer vision applications, thus the application of this hybrid approach might be computationally hard to be applied. In these cases, every two consecutive iteration of active learning might occur with big delay between them, which leads to a wasting time of annotators.

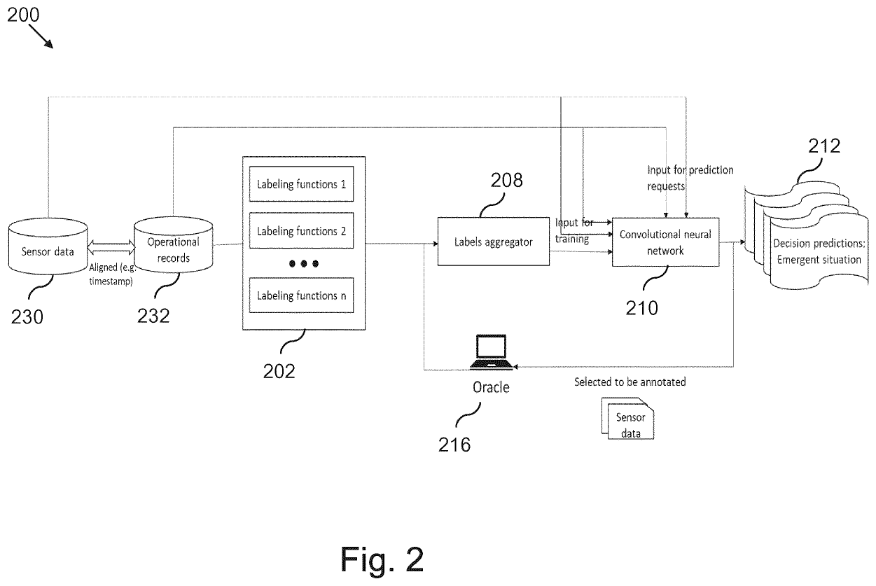

As exemplary use case, an airport system 200 as depicted in FIG. 2 may be considered, where sensors data 230 (i.e., raw data) and operational (contextual) data 232 (i.e., flight schedule, number of checked-in passengers, etc.) are acquired. A raw sensor data 230 can be any measurement from the airport using sensors from building sensors such as CO₂, humidity or Bluetooth monitoring (i.e., sniffing bluetooth messages from mobile devices). Contextual data 232 can be any data that is semantically interpretable for making use of it to make decisions. For instance, an alert raised by an operational staff member in the airport or log information entered by airline staff (e.g., time of a certain flight) can be contextual data.

These data are used to predict certain situations (e.g., crowd at a baggage drop-off counter) and take decisions on a smart operational flow of the airport management (e.g., opening new counters). Assuming lack of ground truth labels for different situations to train a respective ML system, in this case, one can apply a programmatic labeling approach. A domain expert (generally referred to as oracle 216) might write labeling functions 202 on the operational records data 232 (for example heuristics based on thresholds) that might indicate specific situation in the airport. However, those labels are noisy and they are sparse and sometimes even conflicting (i.e., two functions outputting different classification for the same data). A labels aggregator component 208, such a majority voter or a generative model, would aggregate the labels, resulting in the generation of probabilistic labels. These probabilistic labels are then used to train a supervised neural network, such as a recurrent neural network (RNN) or convolutional neural network (CNN) 210. The resulting RNN/CNN 210 is used to predict and take decisions, as shown at 212 For the most uncertain estimation from the neural network 210, the system 200 might require help from an external oracle 216 to have ground-truth labels that are then used to improve the neural network performance. However, every session of oracle input needs a train round of the neural network 210, which can be costly and power consuming.

A similar scenario as described above for a smart airport can be considered for a smart city use case in the context of urban digital twins (as described, e.g., in M. Bauer et al.: “Urban Digital Twins—A FIWARE-based Model”, in De Gruyter, under submission, 2021), where a smart city system includes various sensors (e.g., road occupancy, cameras, parking spot occupancy) and keeps the records of every event happening in the urban environment (e.g., school time schedule, bus schedule, etc.). Basically, these records would enable creating an initial urban digital twin. However, such urban digital twin would lack additional contextual awareness, such as traffic congestion, that might come thanks to knowledge extraction from the raw sensing data. To create a more complete understanding of the environment, a knowledge extraction module using weak supervision and active labeling for training can operate on the sensor data and operational data, similarly to the airport use case described above. The additional knowledge extracted can feed the urban digital twin to connect the missing links between the existing records or create new nodes in the graph database that can represent the urban digital twin, which would lead to a more advanced urban digital twin. The enhanced urban digital twin would support real-time and offline monitoring the smart city, digital twin simulations, and making data-driven decisions.

To summarize, there are two main problems identified in the existing systems that combine active learning with data programming:
1) The uncertain estimation of existing systems of active learning with data programming relies on the training of the end model. However, the end model needs to have a decent amount of labeled training data to converge (especially if it is a CNN) and, thus, reaching an acceptable quality of uncertainty estimation. This requirement is often not satisfied due to the difficulty to implement enough labeling functions or their small coverage.
2) For every cycle of active learning, the end model needs to be fully re-trained. If the end model is a CNN, this operation might take time and being costly.

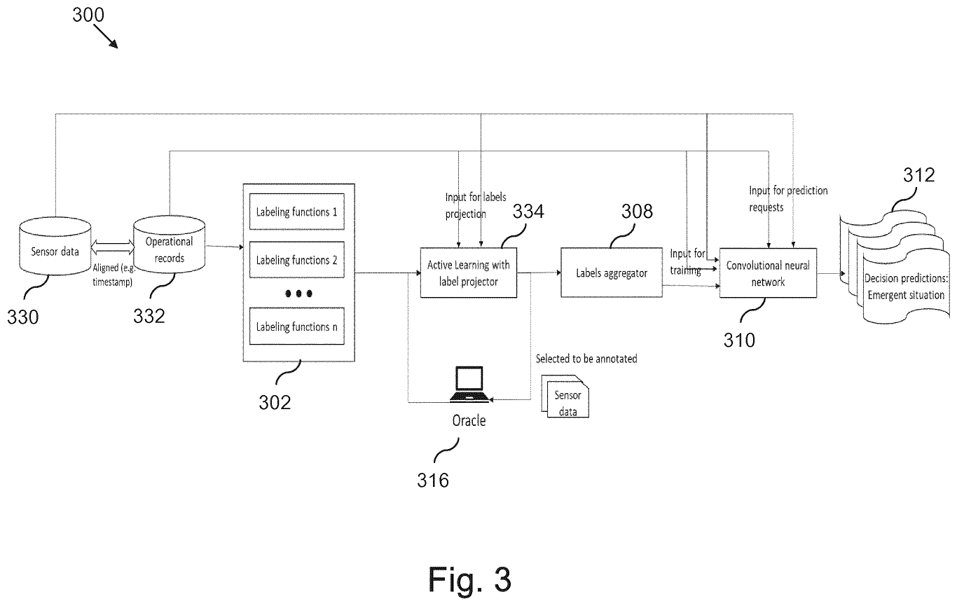

To overcome at least some of the aforementioned issues, embodiments of the present invention improve the training efficiency of the data programming by using active learning. FIG. 3 schematically illustrates an embodiment of a proposed system 300 that leverages an “active learning with label projector” component 334 to minimize the computing effort required to build the decision making system. With the illustrated embodiment, the neural network 310 needs to be trained only once, thus reducing power consumption and time for having the system working at high performance. According to embodiments, the “active learning with label projector” component 334 is configured to use the data points features (e.g. sensors readings 330 or operational records 332) to generate projected labels with uncertainty estimations.

The embodiment illustrated in FIG. 3 may relate to a smart airport where various sensors are deployed and different types of operational records are available to the airport management. A similar scenario could be considered for the urban digital twin of a smart city, as described above in connection with FIG. 3. However, as will be appreciated by those skilled in the art, a plurality of further different application scenarios can be envisioned.

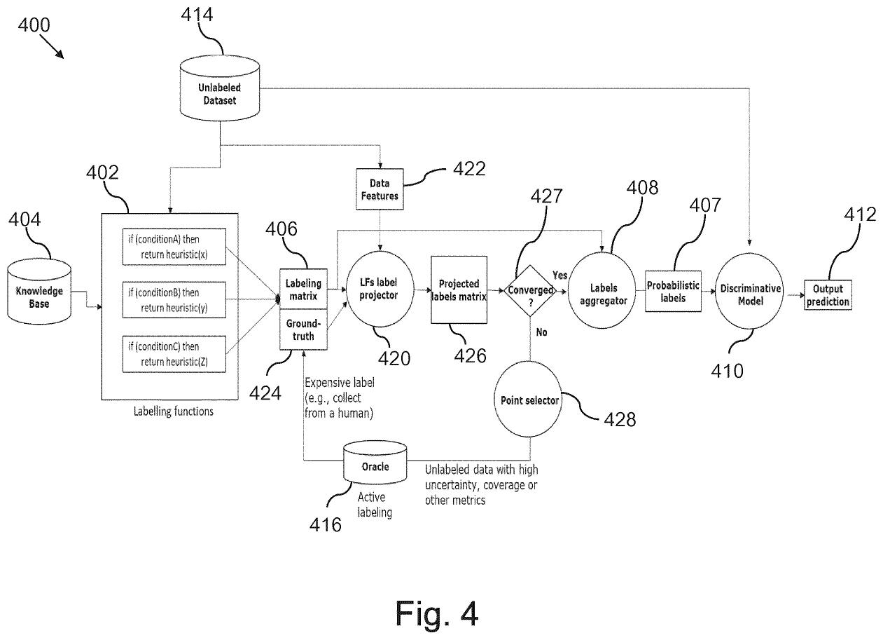

FIG. 4 illustrates an active learning system 400 according to an embodiment of the present invention together with details of the respective workflow. For ease of understanding, however, without loss of generality, the illustrated embodiment assumes a simple binary classification match/non-match problem. As will be appreciated by those skilled in the art, more complex classification problems may be implemented likewise.

Assuming a binary classification match/non-match problem, a projected label is a probability that such label is a match. A LFs labels projector 420 is configured to take advantage of data features 422 from an unlabeled dataset 414 to project the output of the labeling functions 402 on unlabeled data points. The uncertainty of the projected labels are then used—by data point selector 428—to choose those data points to be “actively labeled” through a request to the oracle 416. The LFs labels projector 420 uses the collected ground-labels (ground-truth 424) from the oracle 416 for more and/or better label projections. This process may continue iteratively until a satisfactory result is achieved without involving the process of training the discriminative model 410.

An example of a satisfactory result, for which the decision unit 427 may abort the iteration loop and forward data points along the main processing pipeline to the label aggregator 408, can be having not many uncertain unlabeled data points in the probabilistic labels table 407 (i.e. a number below a configurable threshold). As an example, a satisfactory result might be achieved when the ratio r of data points with projected labels' uncertainty smaller than a given threshold (e.g., p<p_{threshold}) is high (e.g., r>r_{threshold}). The labels aggregator 408 may be configured to aggregate the set of final labels after active labeling, thereby creating the probabilistic labels 407. The discriminative model 410 may then use the probabilistic labels 407 output for further generalization.

The proposed component and new ML pipeline according to the embodiment of FIG. 4 comes along with several advantages compared to the existing active learning, data programming or combination of the two:

The system converges faster since noisy labels are inferred by the LFs label projector 420, therefore the oracle 416 receives less requests.

Reduced training and labels collection time since the discriminative end-model 410 is trained only once after all the labels are collected.

Fewer requests to the oracle 416 since the LFs label projector 420 extends the LFs coverage also to not annotated data points.

The first benefit comes thanks to the projected labels 426 with uncertainty estimating coming from LFs labels projector 420, which takes the data features 422 as well as the labeling function (LF) 402 outputs into account for calculating probabilities. The usage of data features 422 early in the pipeline is a key differentiation from prior art. The second benefit is due to the new approach of hybrid active labeling and programmatic labeling, which excludes the discriminative process from the active learning. The shortened loop is caused by the estimation of the uncertainty early in the pipeline.

### LFs Label Projector

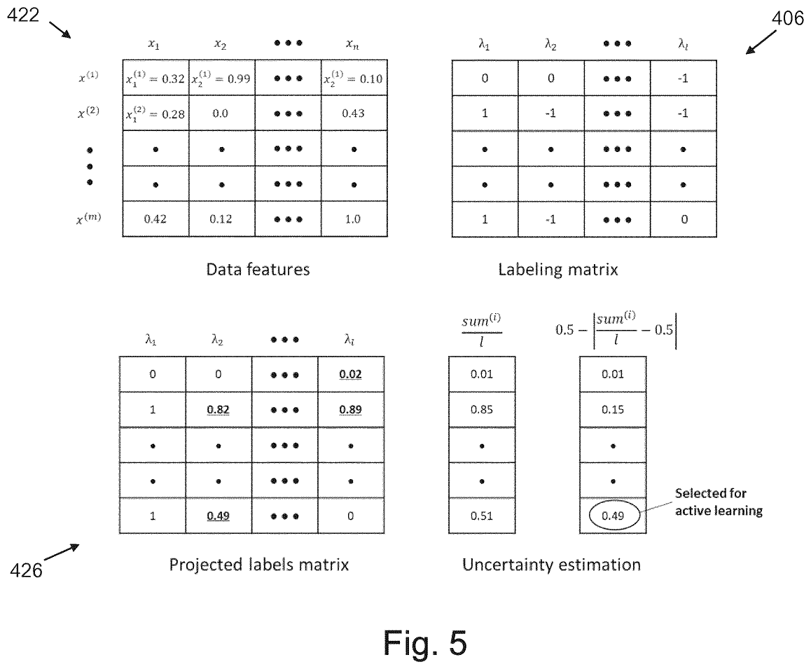

In one embodiment, as the example in FIG. 5, it is considered binary classification, where 1 represents a match and 0 represents a non-match. Abstain values are marked with a −1. Other embodiments might consider multi-task classification or regression problems. Generally, it should be noted that the present invention is in no way limited to any specific machine learning technique.

FIG. 5 shows, in accordance with an embodiment of the invention, the general method for the LFs label projector (e.g. LFs label projector 420 of the embodiment of FIG. 4) to fill the empty points in the labeling outputs (i.e. the ones that LFs 402 do not annotate) with probabilistic values. The undefined values in the labeling matrix (marked as −1) are due to the fact that each labeling function λⱼ has a coverage which is mostly less than the complete dataset. Therefore, labeling function λⱼ may not be able to do any prediction for some of the data points x⁽ⁱ⁾. In other words, λⱼ may abstain from making predictions. The LFs label projector 416 might use a generative weak supervision (WS) method to make these predictions through usage of the data features in the optimization process, e.g., by making use of the following example optimization functions:

$${min}_{{θ}^{λ}} \frac{1}{2} {\sum }_{i : l ( i , j ) = True} {( {( {θ}^{{λ}_{j}} )}^{T} {x}^{( i )} - {λ}_{j}^{( i )} )}^{2} + \frac{λ}{2} {\sum }_{f = 1}^{n} {( {θ}_{j}^{{λ}_{i}} )}^{2} \qquad ( 1 )$$

$${min}_{{θ}^{{λ}_{3}} , {θ}^{{λ}_{2}} … {θ}^{{λ}_{k}}} \frac{1}{2} {{\sum }^{k}}_{j = 1} {\sum }_{i : l ( i , j ) = True} {( {( {θ}^{{λ}_{j}} )}^{T} {x}^{( i )} - {λ}_{j}^{( i )} )}^{2} + \frac{λ}{2} {\sum }_{j = 1}^{k} {\sum }_{f = 1}^{n} {( {θ}_{j}^{{λ}_{i}} )}^{2} \qquad ( 2 )$$

These example optimization function for the LFs label projector step can be used to train the predictions optimally for any given column in the labeling outputs table, using the existing values (i.e., LFs outputs) and data points features. Solving the above optimization problem yields parameters θₛ.

According to embodiments of the present invention, the trained parameters (θₛ) are used for estimating the undefined values (i.e., −1 values) in the labeling matrix. The function l(i, j) is True when the data point x⁽ⁱ⁾ is not abstained by a labeling function λⱼ (labeling output is defined) and False otherwise. The application of θₛ parameters for each −1 value of the labeling matrix generates a value between 0 and 1. When this value is close to 0 the confidence is high to have such label as a non-match class, if this value is close to 1 then the confidence is high to have such label as a match class. Values close to 0.5 indicates low confidence on the label.

In one embodiment, the confidence values in the projected labels matrix for the labels annotated by the LFs (i.e. values in the labeling matrix different than −1) are simply copied into the projected labels. Although this embodiment defines an optimization function considering all possible data points, various simple heuristics can be used to partially fulfill this problem and provide improvements. For instance, one heuristic can be applying labels based on number of stochastic encounters between a labeled and non-labeled data point by a LF and based on that setting a value close to the label given to the labeled data point. For binary classification, starting from 0.5 (no confidence on the estimate), every encounter could shift the confidence closer to the label of the encounter given by an empirical value (e.g., 0.1), such that the value, after encountering twice to label 0, would be 0.3, or encountering twice to label 1, would be 0.7.

While two concrete implementations of the label projector 416 have been described above, it should be noted that further different implementations are possible based on the necessities of the given problem. As will be appreciated by those skilled in the art, many heuristic implementations for the label projector 416 can be created.

In some embodiments, the LF labels projector component 416 may be configured to depend on a distance function between data points. In one embodiment, configured for a dataset composed of real number data features, the distance might be implemented by the Euclidean distance. In other embodiments, e.g. with data composed of text, the distance might be computed by pre-trained NLP (natural language processing) embedding. In a different embodiment with text data, the distance can be computed on a one-hot encoding of tokenized element. In other embodiments with media data (e.g., image, video, audio), the data points can be pre-processed by pre-trained models to extract features. Then, distance function (such as Euclidean) might be applied on the extracted features.

### Uncertainty Estimation

According to embodiments of the present invention, an uncertainty estimation (UE) routine marks those data points with high uncertainty (i.e. above a configurable uncertainty threshold) for the “active learning”, as shown in FIG. 5. Similarly, some values with high confidence (i.e. above a configurable confidence threshold) may not be marked for active labeling. Various metrics can be used for the UE based on the projected labels matrix.

According to an embodiment of the invention, the novel component for active labeling leverages the labeling outputs shown in the example in FIG. 5 for its uncertainty estimation. For instance, it can check all the labeling outputs that are 0 or 1 based on the LF outputs as well as the probabilistic labels that are the outcomes of the LFs label projector 416. A simple yet effective implementation would be the following:

```
Providing as input:
  M ← labeling matrix
  D ← unlabeled dataset {x⁽¹⁾, x⁽²⁾ ... x^{(m)}}, wherein each point x⁽ⁱ⁾ is an
  array of n feature {x₁⁽ⁱ⁾, x₂⁽ⁱ⁾ ... xₙ⁽ⁱ⁾}
  Δ ← set of l labeling functions {λ₁, λ₂, ... , λₗ}
  k ← number of data points to be selected for each active labeling itera-
  tion
Providing as output:
  A ← set of data points to be annotated by an oracle
For each active labeling iteration:
  P ← Apply LFs label projector
  U ←{}
  For each data point x⁽ⁱ⁾
    sum(i) ← Sum all LFs outputs the projected labels confidence
    ${u}^{( i )} ← 0.5 - \vert \frac{{sum}^{( i )}}{l} - 0.5 \vert ; calculate uncertainty$
    U ← U ∪{(u⁽ⁱ⁾, x⁽ⁱ⁾)}
    U ← Order U with ascending u⁽ⁱ⁾
    A ← {}
    For j = 0 to k:
      A ← A ∪ U[j][1]; take data point x(i)
    Return A
```

In other embodiments, the component can be implemented in various ways and with more complex algorithms. Even machine learning algorithms such as using a decision tree or random forest can be used for the uncertainty estimation in some embodiments.

According to embodiment, after the oracle has annotated the chosen data points, the labeling matrix is updated accordingly: each value of data value row of the labeling matrix may be set to the label given by the oracle. The resulting matrix is then again processed by the labels projector. The loop ends when there are enough labels (i.e. above a configurable threshold number) within the projected labels matrix 426.

In some embodiments, the labels of LFs projector may be used at the end of the discriminative model along with an uncertainty estimation that comes from the discriminative model, such as UE based on confidence of the discriminative model. Although this approach would create higher training complexity due to involving the discriminative process, it may produce high accuracy in some scenarios since using all available metrics for uncertainty estimation.

According to embodiments, uncertainty estimations may be used for ranking the uncertain data points and presenting the data points to the oracle based on these uncertainties, as opposed to randomly selecting the data points to be presented to the oracle. As this way of uncertainty estimation is novel and it takes into account the similarities of the unlabeled data points (by certain LFs), it would in certain scenarios lead to higher accuracy since it can eliminate the cases presenting very similar data points to the user.

In the active labeling, the labels that are acquired from the oracle can be used to re-calculate uncertainty estimations and update the existing ranking of the data points. For instance, a data point that has recently been labeled by the oracle can be used to project its label to the very similar data point. This process would continue iteratively. The iteration can happen either every time the oracle gives a label or through batches, i.e., after the oracle labels a bunch of data points.

### Technical Use Case: Computer Vision for Medical Image Processing

Machine learning models for computer vision are very expensive to be trained since often they make use of a Deep Neural Network including many layers which may require a large amount of data and several iterations to be trained. In addition, to label a dataset for computer vision might require weeks or months of work that is very expensive if the annotator is a human domain expert.

Thus, in accordance with embodiments of the present invention, an initial set of labels may be computed by labeling functions and, only on specific uncertainty cases, the oracle may be requested to annotate the respective data points. Since, as explained above in connection with FIG. 4, the loop for deciding which point to annotate does not pass through the training of the discriminative model, the oracle will annotate more points that are meaningful in less time.

Applying the approach described above according to embodiments of the invention, the running of each iteration might take seconds or minutes only, thus it is easier to collect the needed labels in one session. Prior art approaches that involve the training of the discriminative end-model might require hours or even days between consecutive cycles of active learning.

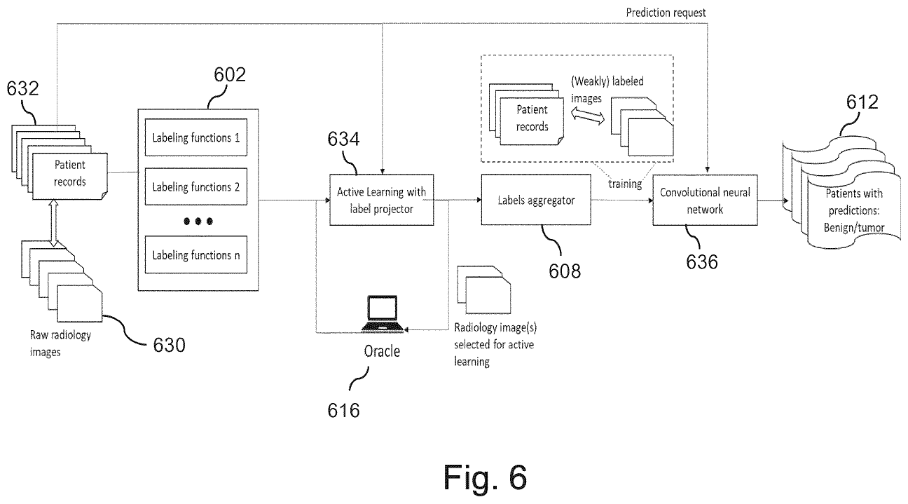

As shown in FIG. 6, embodiments of the present invention can be suitably applied for medical image processing applications, such as tumor detection from radiology images 630 and health records 632 of patients. Even if images can be supported by additional metadata, such as health records of the respective patient, data programming without the active labeling 634 might not be able to label certain data points. In this healthcare domain, domain experts (e.g., doctors, generally referred to as oracle 616 in FIG. 6) can help active labeling of these images that are not confidently labeled by the generative weak supervision.

In detail, the label projector of active learning component 634 is configured to project the output of a set of labeling functions 602 on unlabeled data points, thereby taking advantage of data features from the unlabeled datasets 630, 632. For instance, the labeling functions 602 may be of the same form as illustrated in FIG. 1, i.e. if a certain condition is met then the respective function returns a specific heuristic. The uncertainty of the projected labels is estimated, e.g., using generative weak supervision, and is then used to choose those data points to be “actively labeled” through a request to the oracle 616. The active learning component 634 may use the collected ground-labels from the oracle 616 for more and/or better label projections. This process may continue iteratively until a satisfactory result is achieved without involving the process of training the discriminative model, i.e. convolution neural network (CNN) 636 in the illustrated embodiment.

After the active labeling process is finished, the set of final labels may be aggregated by the labels aggregator 608, thereby creating a set of probabilistic labels representing a subset of the whole dataset. This final outcome of the labels aggregator 608 can be fed to the CNN 636 for training. After training, CNN 636 is ready to receive prediction requests and to make predictions 612 in terms of patients' tumor detection.

### Technical Use Case: Ontology Matching for Data Fabric in Humanitarian AI

There have been various open datasets for humanitarian use such as for estimating weapon contamination risk in certain regions of the world. These datasets include various data modalities such as geographic information systems (GIS) datasets, satellite images, technical reports, casualty datasets, agricultural measurements, UAV images, OpenStreetMap datasets; and so on. For analyzing and estimating the risk in a given region, these datasets can be combined and fed to machine learning models. In particular, different contextual information from these datasets (e.g., entity types, relations, etc.) can be extracted and automatically matched with a backbone ontology using data programming. A backbone ontology is the base ontology to model data used by a homogenized data layer.

For ontology matching scenarios in general, data programming with active learning is considered beneficial in order not to miss any match between two entities, i.e., an entity model in the ontology and an entity model from a real dataset. The users can first write labeling functions to match the entities using various techniques of text processing ranging from simple distancing (e.g., Levenshtein distance) or pre-trained machine learning models such as Spacy (for reference, see Benoit, K., & Matsuo, A. (2018). Spacyr: Wrapper to the spaCy NLP library. Retrieved from https://CRAN.R-project.org/package=spacyr). As a simple example, if the Spacy distance or Levenshtein distance between two entity names is small, the two entities might be able to match to each other. On the other hand, if these distance values are too large, the two entities may not match to each other. Active labeling might be necessary for the entities that have average distance from each other where the machine learning model (e.g., discriminative model of data programming) does not have much confidence.

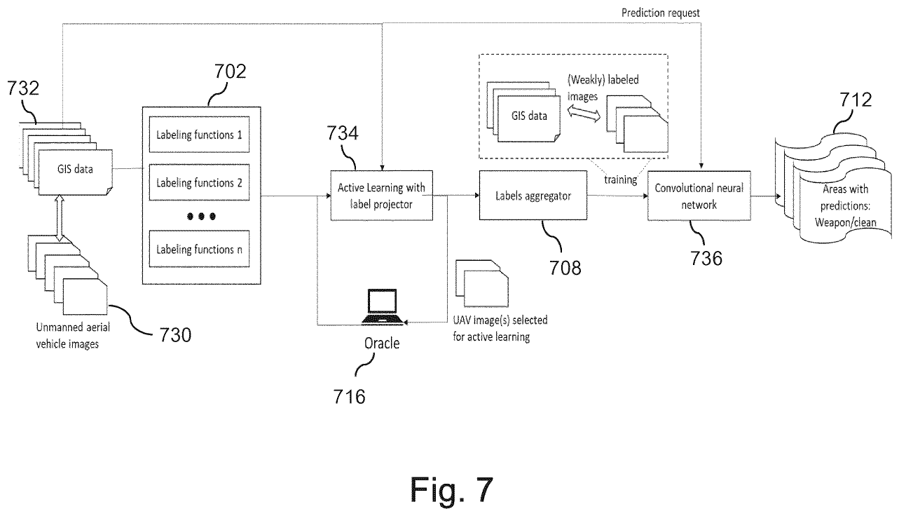

FIG. 7 illustrates the use of a system according to embodiments of the present invention for the humanitarian AI applications in the context of weapon contamination detection with UAV images 730 and additional dataset (e.g., GIS data 732). The active labeling component 734 according to embodiments of the present invention, including, e.g., the LFs label projector 420 of the system shown in FIG. 4, enables the uncertainty estimation after the label projection, as described in detail above in connection with FIG. 4. As shown in FIG. 7, the active labeling component 734 operates both on the output of a set of labeling functions 702 and on data features from the GIS dataset 732. Using various uncertainty estimation metrics, depending on the embodiments, based on the outcome of the active labeling component 734 data can be selected for being actively labeled by a human oracle 716. After the active labeling process is finished, the final outcome of the label aggregator 708, which is a set of probabilistic labels representing a subset of the whole dataset, can be fed to the discriminative model. In the illustrated embodiment, the discriminative model is a CNN 736, which is trained based on (weakly) labeled images of the GIS data 732. After training, CNN 736 is ready to receive prediction requests and to make predictions 712 in terms of areas either covered with or cleaned from weapons.

The advantage of the invention comes from the fact that there have been a vast number of datasets with many modalities. Various ontologies have many concepts, e.g., thousands of concepts are represented in a graph structure. Hence, existing way of data programming with active labeling would result in long training times and complexity due to the uncertainty estimation using the discriminative model. Active labeling using the generative weak supervision for uncertainty estimation can be very efficient, as shown in the example implementation of the invention, avoiding the repeated training of the discriminative model.

Concluding, it is worth noting that matching many datasets into a common backbone ontology would result in a highly contextualized dataset. This dataset can be further enriched and using machine learning and can be considered as the data fabric for humanitarian AI.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A computer-implemented machine learning (ML) method, the method comprising:
a) computing a labeling matrix by applying a set of labeling functions (LFs) to data points of an unlabeled dataset;
b) generating a projected labels matrix by computing, based on the labeling matrix, LFs labels projections to undefined labels;
c) estimating, for each labeled data point, an uncertainty of a respective label of the each labeled data point based on an output of the LFs output and the LFs labels projections;
d) selecting data points depending on the uncertainty estimated for the respective label of the each data point; and
e) submitting labeling request for the selected data points to an oracle and updating the labeling matrix according to responses of the oracle.

2. The method according to claim 1, further comprising:
iteratively repeating steps b)-e) until the projected labels matrix comprises a number of labels above a configurable threshold number.

3. The method according to claim 1, further comprising:
generating probabilistic labels by aggregating labels from the projected labels matrix.

4. The method according to claim 3, further comprising:
training an end classifier with the probabilistic labels after active labeling according to steps b)-e) is completed.

5. The method according to claim 1, further comprising:
computing the LFs labels projection to undefined labels by applying ML techniques or heuristics.

6. The method according to claim 5, wherein a heuristic comprises applying labels based on a number of stochastic encounters between a labeled data point and non-labeled data point by an LF and setting, based thereupon, a value close to the label given to the labeled data point.

7. The method according to claim 1, wherein the generating the projected labels matrix of step b) is performed by calculating probabilities based on data features of non-labeled data points and outputs of the LFs.

8. The method according to claim 1, wherein the generating the projected labels matrix of step b) is performed depending on a distance function between data points.

9. The method according to claim 1, wherein the uncertainty of the respective label of the each labeled data point is estimated by machine learning algorithms, comprising using a decision tree or random forest, or heuristics.

10. The method according to claim 1, further comprising:
projecting labels with a confidence estimation for undefined labels after the LFs application using the computed labels from other data points and their features.

11. The method according to claim 1, wherein the selection of data points according to step d) is performed by:
ranking the labeled data points according to the estimated uncertainty of the respective labels, and
selecting, in each iteration, a predefined number of the highest ranked labeled data points.

12. The method according to claim 11, further comprising:
using labels that are acquired from the oracle to re-calculate uncertainty estimations; and
update the existing ranking of the labeled data points according to the re-calculated uncertainty estimations.

13. The method according to claim 1, wherein the set of LFs are configured to provide a confidence of their annotation.

14. A machine learning (ML) system, the system comprising one or more processors which, alone or in combination, are configured to provide for execution of a method comprising the steps of:
a) computing a labeling matrix by applying a set of labeling functions (LFs) to data points of an unlabeled dataset;
b) generating a projected labels matrix by computing, based on the labeling matrix, LFs labels projections to undefined labels;
c) estimating, for each labeled data point, an uncertainty of a respective label of the each labeled data point based on an output of the LFs and the LFs labels projections;
d) selecting data points depending on the uncertainty estimated for the respective label of the each data point; and
e) submitting labeling request for the selected data points to an oracle and updating the labeling matrix according to responses of the oracle.

15. A tangible, non-transitory computer-readable medium having instructions thereon, which upon execution by one or more processors, alone or in combination, provide for execution of a machine learning (ML) method, the method comprising:
a) computing a labeling matrix by applying a set of labeling functions (LFs) to data points of an unlabeled dataset;
b) generating a projected labels matrix by computing, based on the labeling matrix, LFs labels projections to undefined labels;
c) estimating, for each labeled data point, an uncertainty of a respective label of the each labeled data point based on an output of the LFs and the LFs labels projections;
d) selecting data points depending on the uncertainty estimated for the respective label of the each data point; and
e) submitting labeling request for the selected data points to an oracle and updating the labeling matrix according to responses of the oracle.

16. The method according to claim 1, wherein the responses of the oracle are generated through usage of data features in an optimization process.
